(19) United States
(12) Patent Application Publication
(10) Pub. No.: US 2026/0257497 A1
(43) Pub. Date: Sep. 3, 2026

(54) PRINTING APPARATUS AND METHOD OF CONTROLLING PRINTING APPARATUS

(71) Applicant: CANON KABUSHIKI KAISHA, Tokyo (JP)

(72) Inventor: TAKUMI SUZUKI, Kanagawa (JP)

(21) Appl. No.: 19/537,916

(22) Filed: Feb. 12, 2026

(30) Foreign Application Priority Data
Feb. 28, 2025 (JP) 2025-031418

(51) Int. Cl. B41J 11/00; B41J 2/045; B41J 2/165

(52) U.S. Cl. CPC B41J 11/008; B41J 2/04586; B41J 2/16508; B41J 11/0095

(57) ABSTRACT

A printing apparatus includes: a carriage carrying a print head configured to eject an ink onto a print medium; an encoder configured to output a signal indicating a position of the carriage; a position counter configured to count a value based on the signal output from the encoder; a unit configured to generate an ejection signal to be used for ejection by the print head based on the value of the position counter; a unit configured to hold the value of the position counter, as reference position information, which corresponds to a position where an absolute position and position information of the carriage are secured; and a unit configured to update the position counter based on the reference position information in a case where the value of the position counter is abnormal.

### BACKGROUND

### Field of the Technology

The present disclosure relates to a technique for specifying the position of a carriage of a printing apparatus.

### Description of the Related Art

Printing apparatuses that print images using an inkjet method have been known. Such a printing apparatus performs printing by ejecting inks from a print head onto a print medium while scanning a carriage carrying the print head. During each scan of the carriage, the printing apparatus obtains position information of the carriage by reading an encoder disposed in the main scanning direction with an optical sensor. Based on the obtained position information, the printing apparatus determines the timing for ejection from the print head, based on which the printing apparatus ejects inks from the print head.

In a case where the encoder signal obtained from the encoder has abnormality, there is a possibility that inks may be ejected unintendedly and consequently cause image defects. Japanese Patent Laid-Open No. 2009-220346 (hereinafter referred to as "Document 1") is disclosed as a correction technique for a case where the encoder signal has abnormality. Document 1 discloses that, in a case where an encoder analysis unit determines that an encoder signal is abnormal after a carriage is scanned, a correction condition for a single scan of the carriage is determined based on information on the encoder signal periods for a single scan of the carriage. Document 1 further discloses that, in a case where a next print job is executed, the scanning of the carriage and the ink ejection from the print head are controlled based on the correction condition.

Document 1 is a technique for correcting the encoder signals for the next and subsequent print jobs. Hence, Document 1 cannot handle image defects attributable to the effect of an unexpected noise.

### SUMMARY

The present disclosure is directed to properly specifying the position of a carriage.

A printing apparatus according to an aspect of the present disclosure includes: a carriage carrying a print head configured to eject an ink onto a print medium; an encoder configured to output a signal indicating a position of the carriage; a position counter configured to count a value based on the signal output from the encoder; a unit configured to generate an ejection signal to be used for ejection by the print head based on the value of the position counter; a unit configured to hold the value of the position counter, as reference position information, which corresponds to a position where an absolute position and position information of the carriage are secured; and a unit configured to update the position counter based on the reference position information in a case where the value of the position counter is abnormal.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective exterior view illustrating an overview of a printing apparatus;

FIG. 2 is a perspective view schematically illustrating an internal configuration of the printing apparatus;

FIG. 3 is a diagram illustrating an example of a schematic circuit configuration of the printing apparatus;

FIGS. 4A and 4B are diagrams illustrating examples of encoder signals from an encoder and position counters;

FIG. 5 is a flowchart illustrating an example of operation in a case where a scanner unit as a cover is closed.

### DESCRIPTION OF THE EMBODIMENTS

An embodiment of the present disclosure will be specifically described below with reference to the accompanying drawings. Note that the following embodiment does not limit the contents of the present disclosure, and not all of the combinations of the features described in the following embodiment are necessarily essential for the solution to be provided by the present disclosure. Note that identical constituent elements are denoted by the same reference sign. Also, relative positions, shapes, and the like of the constituent elements described in the embodiment are mere examples and are not intended to limit the scope of this disclosure only to those.

Note that the term "printing" in the following description of the embodiment not only includes formation of meaningful information such as characters or a figure but broadly encompasses formation of an image, a design, a pattern, and the like on a sheet. Also, in the present embodiment, a roll sheet is assumed to be the sheet, but the sheet may be cut paper, fabric, plastic film, or the like. Further the term "ink" is to be broadly interpreted, and represents a liquid that may be applied onto the sheet for formation of an image, a design, a pattern, or the like, processing of the sheet, or processing of ink.

### First Embodiment

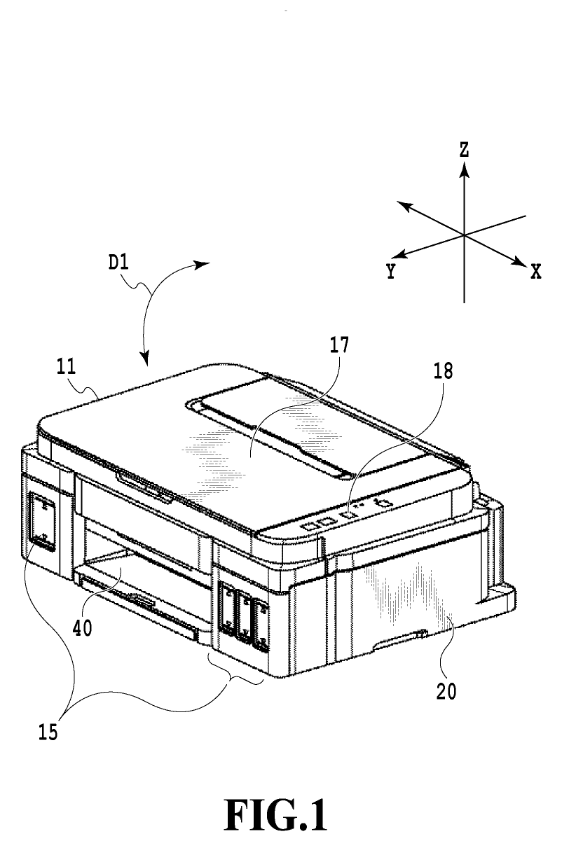

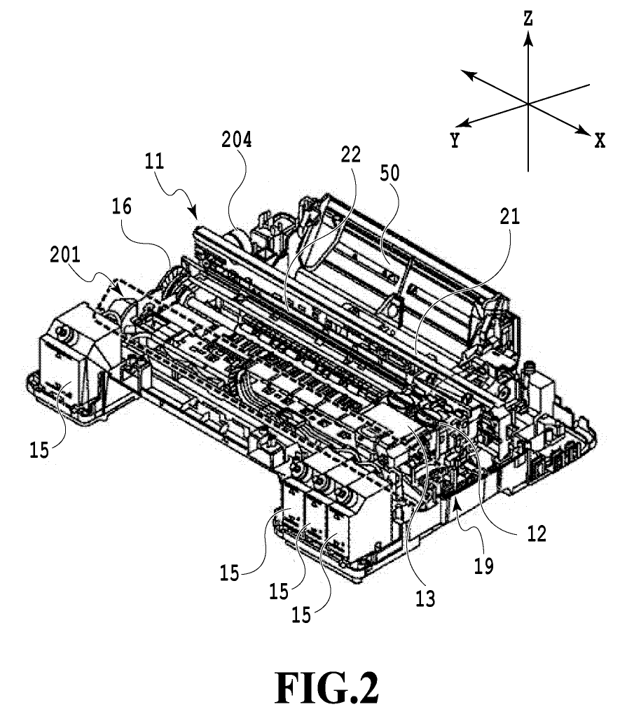

FIG. 1 is a perspective exterior view illustrating an overview of an inkjet printing apparatus (hereinafter referred to as "printing apparatus") 11 in the present embodiment. As illustrated in FIG. 1, a printing apparatus 11 includes a body part 20, which is a housing, a print head 13 (see FIG. 2) which performs a printing operation on a print medium (not illustrated), and ink tanks 15 serving as ink containers to accommodate inks to be supplied to the print head 13. In the present embodiment, the ink tanks 15 are disposed at the front face of the body part 20. Also, a scanner unit 17 which performs document reading operations and an operation input unit 18 which is capable of performing operations such as inputting the user's command are provided at the top of the body part 20.

The scanner unit 17 is an opening and closing unit which is disposed at the top of the body part 20 and is capable of being opened and closed in the direction of arrow D1 relative to the body part 20. The scanner unit 17 functions also as a cover member which covers the inside of the body part 20. By opening the scanner unit 17, the user can access the inside of the body part 20. That is, the scanner unit 17 is an access cover for the user to access the inside of the body part 20.

The operation input unit 18 includes a power key, for example. The user can operate the power key to issue an instruction to power on the printing apparatus 11 and an instruction to power off the printing apparatus 11. In response to an operation on the power key, the state of the printing apparatus 11 switches and transitions between a power-on state (software power-on state) and a power-off state (software power-off state).

At the front (+Y side) of the body part 20, multiple ink tanks 15 storing inks are provided. Each ink tank 15 stores a different type of ink. For example, each ink tank 15 stores an ink of a different color. The user can open the scanner unit 17 and perform an operation of refilling the ink tanks 15 with inks and the like. Also, in a case where the scanner unit 17 is opened, a carriage 12 (see FIG. 2) moves a replacement position at which the print head 13 can be replaced.

FIG. 2 is a perspective view schematically illustrating an internal configuration of the printing apparatus 11. The body part 20 of the printing apparatus 11 is provided with various mechanisms to be used for printing. An example of these mechanisms will be described below. The body part 20 includes the print head 13, a feeding unit 50 which feeds a print medium, a conveyance roller 16 which conveys the print medium, a conveyance motor 201 which drives the conveyance roller 16, and a discharge unit 40 (see FIG. 1) which discharges the print medium. The conveyance roller 16 is driven by the conveyance motor 201 through gears not illustrated. The print medium is fed from the feeding unit 50 into the printing apparatus 11 by rollers not illustrated. The fed print medium is subjected to a printing operation by the print head 13 while being conveyed by the conveyance roller 16. The print medium after the printing is discharged to the outside of the printing apparatus 11 from the discharge unit 40. Also, the printing apparatus 11 includes a maintenance unit 19, main chassis 21, timing belt 22, and carriage motor 204 for the print head 13.

While being supported by the main chassis 21, the carriage 12 is driven by the carriage motor 204 through the timing belt 22 to move along a main scanning direction (X direction) intersecting the conveyance direction of the print medium (Y direction). In the present embodiment, the conveyance direction and the main scanning direction perpendicularly intersect each other. The print head 13 is mounted on the carriage 12, and performs a printing operation of printing an image corresponding to a single band on the print medium by ejecting ink droplets while moving in the main scanning direction. After the image corresponding to a single band is printed on the print medium, the conveyance roller 16 conveys the print medium by a predetermined amount in the conveyance direction (intermittent conveyance operation). The operation of printing a single band and the intermittent conveyance operation are repeated to print an image on the entire print medium.

The maintenance unit 19 is provided at one end of the movement range of the carriage 12. The maintenance unit 19 maintains and recovers the liquid ejection performance of the print head 13. Nozzles in the print head 13 may be clogged if the inks are not ejected for a prolonged period or in other similar cases. To address such a decrease in the performance of the print head 13, a recovery operation is regularly performed. The maintenance unit 19 includes, for example, a capping member which caps the ejection face of the print head 13, a pump which sucks in liquids from the print head 13 through the capping member, and so on. The capping prevents or reduces drying of the nozzles. The suction by the pump discharges inks with increased viscosity from the nozzles.

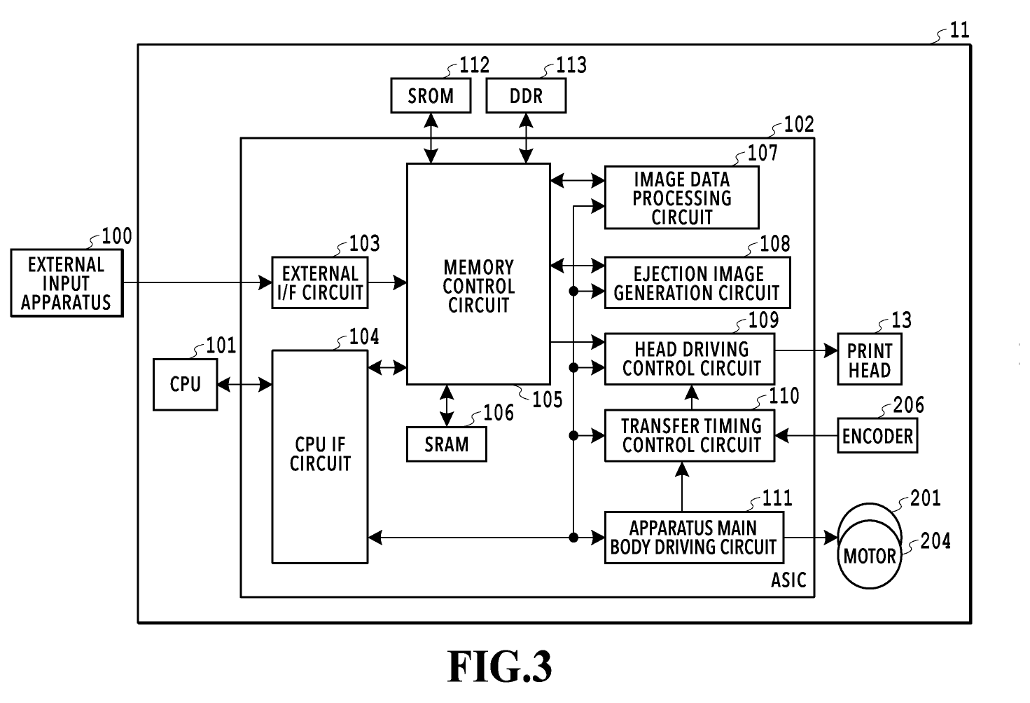

FIG. 3 is a diagram illustrating an example of a schematic circuit configuration of the printing apparatus 11 in the present embodiment. The printing apparatus 11 is connected to an external input apparatus 100, such as a personal computer (PC), a hard disk drive (HDD), or a smartphone. A central processing unit (CPU) 101 is a CPU for controlling an entire printer system. An application-specific integrated circuit (ASIC) 102 performs hardware control dedicated for the printer. The ASIC 102 has an external interface (IF) circuit 103, a CPU interface circuit 104, a memory control circuit 105, and a static random-access memory (SRAM) 106. Also, the ASIC 102 has an image data processing circuit 107, an ejection image generation circuit 108, a head driving control circuit 109, a transfer timing control circuit 110, and an apparatus main body driving circuit 111.

The operations of the circuits inside the ASIC 102 will now be described. The external interface circuit 103 is connected to the external input apparatus 100. The external interface circuit 103 may include an interface circuit to be connected to the external input apparatus, such as a universal serial bus (USB) interface circuit, a wireless communication interface circuit, a local area network (LAN) interface circuit, or an integrated development environment (IDE) interface circuit. The CPU interface circuit 104 is connected to the CPU 101 and controls communication between blocks in the ASIC 102 based on instructions from the CPU 101.

The memory control circuit 105 is connected to the external IF circuit 103, the SRAM 106, the image data processing circuit 107, the ejection image generation circuit 108, the head driving control circuit 109, the SROM 112, and a double data rate synchronous dynamic RAM (DDR SDRAM) 113. The memory control circuit 105 transfers image data input from the external input apparatus 100 to the SRAM 106. The memory control circuit 105 also controls loading and writing of programs and various parameters to the SROM 112 and also controls loading and writing of data to the SRAM 106 and the DDR SDRAM 113. The SRAM 106 is a work buffer, in which print image data is divided into particular sizes and stored. As the SRAM 106, a number of SRAMs 106 corresponding to the number of colors of inks to be ejected or the number of nozzles may be included.

The image data processing circuit 107 performs image processing on the image data stored in the SRAM 106. The image processing includes, but is not limited to, processes such as boundary processing, edge processing, horizontal–vertical (HV) conversion, smoothing, or ejection failure compensation. The ejection image generation circuit 108 converts the image data subjected to the image processing into data of a format suitable for the nozzles of the print head 13 (hereinafter referred to as "ejection image data").

The transfer timing control circuit 110 generates a transfer timing signal for the ejection image data by multiplying a signal input from an encoder 206. The head driving control circuit 109 drives the print head 13 by transferring the ejection image data in the form of an ejection signal with driving pulses with the timing indicated by the transfer timing signal to the print head 13.

The DDR SDRAM 113 is a reception buffer externally connected to the ASIC 102. The DDR SDRAM 113 stores image data subjected to an image correction process. The apparatus main body driving circuit 111 generates control signals for driving the conveyance motor 201 and the carriage motor 204 based on based on signals from the encoder 206. The apparatus main body driving circuit 111 obtains detection results from various sensors (not illustrated) including the encoder 206.

The encoder 206 is, for example, a rotary encoder, and converts an amount of mechanical displacement of rotation into an electric signal. The printing apparatus 11 is configured to detect the position of the carriage 12 by processing the encoder signals output from the encoder 206. In the present embodiment, the encoder 206 generates two pulses with different phases. These two pulses will be referred to as "A-phase signal" and "B-phase signal." The rotational direction, i.e., the moving direction of the carriage 12, is specified based on which of the pulses of the A-phase signal and B-phase signal rises first.

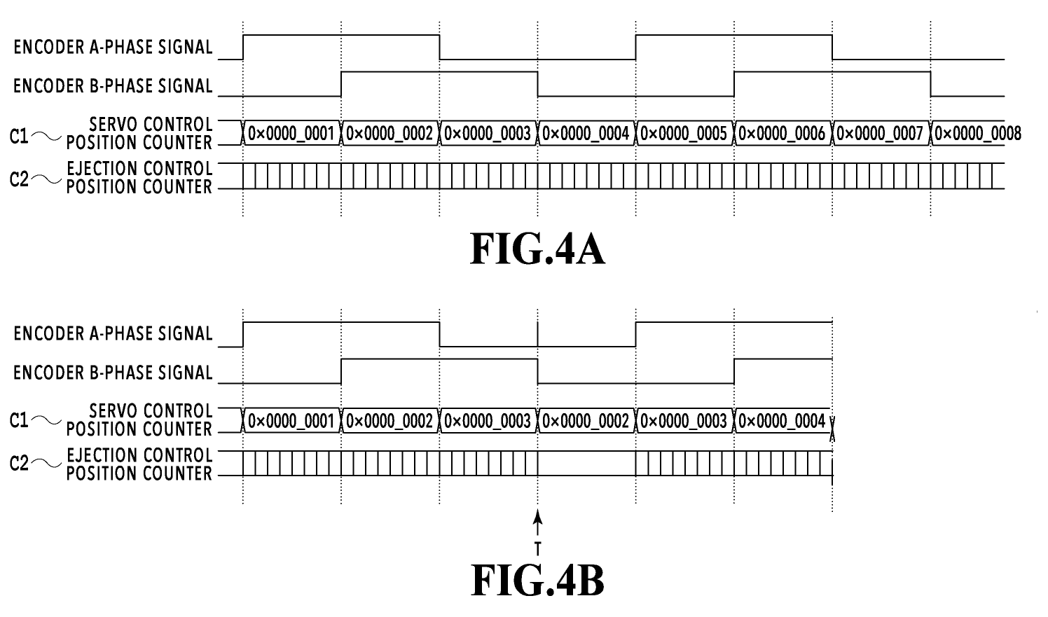

FIGS. 4A and 4B are diagrams illustrating examples of the encoder signals from the encoder 206 and position counters in the present embodiment. FIG. 4A is a timing chart illustrating a relationship between the encoder signals in a normal state and the position counters. FIG. 4B is a timing chart illustrating a relationship between the encoder signals one of which is affected by noise and the position counters.

First, the relationship between the encoder signals in a normal state and the position counters will be described using FIG. 4A. In the present embodiment, two counters are included as the position counters. A servo control position counter C1 is used to control the movement of the carriage 12. An ejection control position counter C2 is used to control the ink ejection from the print head 13. The servo control position counter C1 is provided in the transfer timing control circuit 110. The ejection control position counter C2 is provided in the head driving control circuit 109.

The encoder A-phase signal and the encoder B-phase signal are input into the transfer timing control circuit 110 from the encoder 206. The value of the servo control position counter C1 is generated by the transfer timing control circuit 110 based on the encoder A-phase signal and the encoder B-phase signal. The number of bits needed for the servo control position counter C1 is determined based on the main body size and the resolution. In the present embodiment, the servo control position counter C1 is 32 bits.

In the present embodiment, the servo control position counter C1 is configured to count up in response to a rise or a fall of the encoder A-phase signal and the encoder B-phase signal in the transfer timing control circuit 110. Note that the configuration to count up can be set in any desirable manner. Only one of the encoder's phase signals may be used. Also, the counter can count up only in response to a rise or the like.

The initial value of the ejection control position counter C2 is generated by the head driving control circuit 109 based on the servo control position counter C1 and with the number of droplets taken into account. The ejection control position counter C2, which is used to control the ink ejection from the print head 13, needs to have a higher resolution than the resolution used for the servo control position counter C1. Thus, a multiple of the resolution of the servo control position counter C1 is used as the resolution of the ejection control position counter C2. In the present embodiment, the resolution of the ejection control position counter C2 is a value obtained by multiplying the resolution of the servo-control position counter C1 by 8. In the present embodiment, assuming that an encoder sensor with a resolution of 150 dpi is used, the resolution of the servo control position counter C1 is 600 dpi and the resolution of the ejection control position counter C2 is 4800 dpi.

The initial position of the carriage 12 may be any position. For example, the initial position may be the position at which the print head 13 is capped by the maintenance unit 19, or the initial position may be the replacement position for the print head 13. The initial position of the carriage 12 is set by writing any value to the servo control position counter C1 from the CPU 101. At the same time as this writing of any value to the servo control position counter C1, the same value is written to higher-order bits of the ejection control position counter C2, and the number of droplets is cleared. For high-speed processing, the ejection control position counter C2 is configured to count based on edge information of the encoder input from the transfer timing control circuit 110. Specifically, the ejection control position counter C2 counts based on the edge information of the encoder input from the transfer timing control circuit 110 until the CPU 101 writes any value to the servo control position counter C1 again as the initial position of the carriage 12. In the present embodiment, the edge information is rising signals and falling signals, as described earlier.

Next, the relationship between the encoder signals one of which is affected by noise and the position counters will be described using FIG. 4B. Here, it is assumed that the encoder A-phase signal is affected noise. Specifically, assume that, as indicated by a timing T, the encoder A-phase signal is affected by noise in a state where the servo control position counter C1 is 0x0000_0003 such that a rising signal is input as the A-phase signal into the transfer timing control circuit 110. As illustrated in FIG. 4A, the servo control position counter C1 is configured such that the servo control position counter C1 at 0x0000_0003 counts up in a case where the encoder A-phase signal is 0 when the encoder B-phase signal falls. However, as indicated by the timing T, in a case where the encoder A-phase signal is affected by noise in a state where the servo control position counter C1 is 0x0000_0003, the servo control position counter C1 may erroneously recognize that the encoder A-phase signal has risen. As described above, the moving direction of the carriage 12 is specified based on which of the pulses of the encoder A-phase signal and B-phase signal rises first. For this reason, in a case where the servo control position counter C1 erroneously recognizes that the encoder A-phase signal has risen at the timing T, the servo control position counter C1 recognizes that the direction has reversed, and counts down after the timing T, instead of counting up. The ejection control position counter C2, on the other hand, does not expect the direction to change in the middle of the ejection control, and is configured to count based on the edge information of the encoders input from the transfer timing control circuit 110. For this reason, the ejection control position counter C2 does not properly count after the timing T, as illustrated in FIG. 4B. Specifically, since an unexpected pattern is input as the edge information of an encoder, the ejection control position counter C2 does not count up, and then starts counting again based on the normal edge information of the encoder input after that. This causes a shift in the position. Specifically, the correlation between the servo control position counter C1 and the ejection control position counter C2 is disrupted. In a case where ejection is performed with the counters in such a state, the inks may be ejected at positions different from the expected positions and affect the image. Also, the carriage 12 may fail to stop at the right position.

The encoder signal may be affected by noise as described above mainly by noise entering the printing apparatus 11 in a case where the scanner unit 17 is opened. For example, assume that the position indicated by the timing T in FIG. 4B is a position where the carriage 12 is stopped at the replacement position in response to opening the scanner unit 17. In a case where the encoder A-phase signal is affected by noise in this state such that the servo control position counter C1 erroneously recognizes input of a rise in the encoder A-phase signal, the servo control position counter C1 recognizes that the direction has reversed and counts down although the carriage 12 has not actually moved. The ejection control position counter C2, on the other hand, does not count. This disrupts the correlation between the servo control position counter C1 and the ejection control position counter C2.

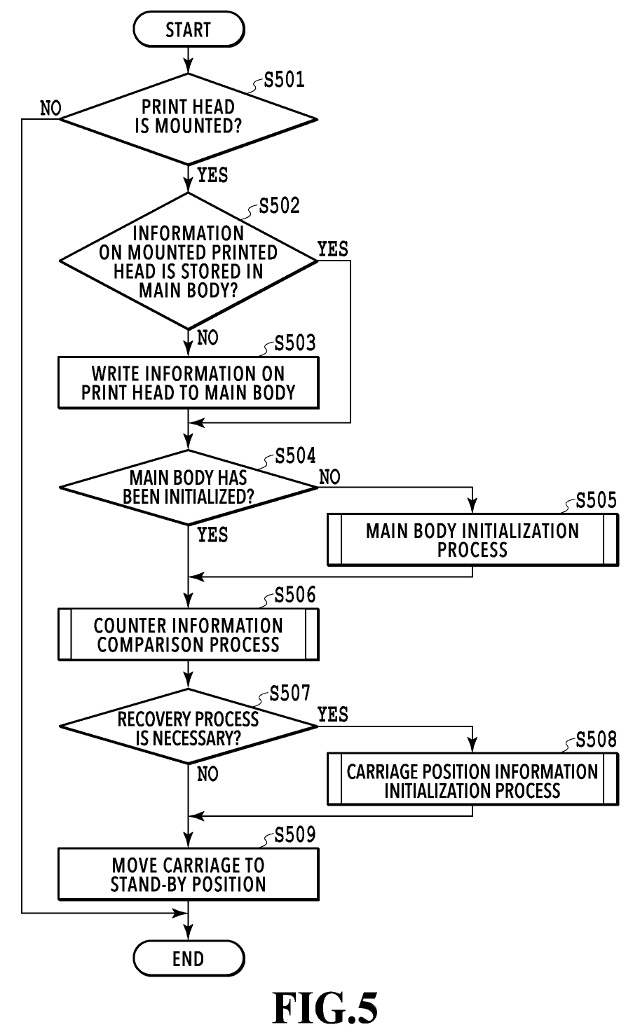

FIG. 5 is a flowchart illustrating an example of operation in a case where the scanner unit 17 as a cover is closed in the present embodiment. The present embodiment assumes that, in a case where the scanner unit 17 is opened, noise enters the printing apparatus 11 and affects an encoder signal and consequently an abnormal value is written to a position counter, as described above. Thus, in FIG. 5, an operation flow in a case where the scanner unit 17 as a cover is closed is described which includes a process of correcting the value of the position counter to a normal value in a case where the cover is closed. Note that, as will be described later, the process of correcting the position counter in the present embodiment is not limited to a process performed in a case where the scanner unit 17 as a cover is closed. The operation in the flowchart illustrated in FIG. 5 is started in a case where the printing apparatus 11 detects closing of the scanner unit 17 as a cover with a cover sensor not illustrated. Note that, in a case where the scanner unit 17 is opened, the carriage 12 moves to the replacement position, at which the print head 13 can be replaced, as described earlier. That is, the carriage 12 is in a stopped state at the replacement position, at which the print head 13 can be replaced, when the flowchart illustrated in FIG. 5 is started.

In S501, the printing apparatus 11 determines whether a print head 13 is mounted. If a print head 13 is not mounted, the printing apparatus 11 terminates the process of the flowchart illustrated in FIG. 5 and notifies the user that a print head 13 is not mounted. If a print head 13 is mounted, the process proceeds to S502.

In S502, the printing apparatus 11 determines whether information on the print head 13 mounted in the printing apparatus 11 is stored in the main body. For example, the ASIC 102 makes this determination by reading out an ID of the print head 13 through the memory control circuit 105 and determining whether that ID is stored in the SROM 112. If there is information on the mounted print head 13, the process proceeds to S504. If there is no information on the mounted print head 13, it is determined to be a print head that has not been connected to the printing apparatus 11, and the process proceeds to S503.

In S503, a process of writing the information on the print head 13 to the main body of the printing apparatus 11 is performed. For example, the ASIC 102 reads out the information on the print head 13 through the memory control circuit 105 and stores it in the SROM 112. The information on the print head includes the type of the head, ejection failure nozzle information, the manufacturing date, and so on.

In S504, the printing apparatus 11 determines whether the main body has been initialized. The initialization of the main body refers to bringing the mechanisms of the printing apparatus 11 to be used for printing into a state where printing can be performed. Specific examples of such a state include a state where the carriage 12 can be moved to a predetermined position at which a recovery operation can be performed. Also, the initialization of the main body includes controlling the conveyance motor 201 to achieve a state where no print medium is present on the conveyance path through which to convey a print medium, positioning the maintenance unit 19 such that it will not obstruct the carriage 12, and so on. Note that the carriage 12 remains in the stopped state at the replacement position while the initialization of the main body is executed.

If the main body initialization process has been completed, the process proceeds to S506. If the main body initialization process has not been completed, the process proceeds to S505. In S505, the above-described main body initialization process is performed. After the main body initialization process is completed in S505, the process proceeds to S506.

In S506, the printing apparatus 11 performs a counter information comparison process. The counter information comparison process is executed by the CPU 101, for example. In the counter information comparison process, the servo control position counter C1 and the ejection control position counter C2 are compared with each other. As described earlier, the correlation between the servo control position counter C1 and the ejection control position counter C2 will be disrupted in a case where an encoder signal is affected by noise. Specifically, as described earlier, the ejection control position counter C2 is configured such that its value is a multiple of the value of the servo control position counter C1. If the result of the counter comparison indicates that the value of the ejection control position counter C2 is not a multiple of the value of the servo control position counter C1, it is determined that the correlation has been disrupted. This disruption of the correlation occurs in the state where the carriage 12 is stopped at the replacement position. If the correlation between the servo control position counter C1 and the ejection control position counter C2 has been disrupted, the printing apparatus 11 determines that a recovery process is necessary.

In S507, the printing apparatus 11 determines whether a recovery process is necessary based on the result of the comparison process in S506. If it is determined that a recovery process is not necessary, the process proceeds to S509. If it is determined that a recovery process is necessary, the process proceeds to S508.

In S508, the printing apparatus 11 performs a carriage position information initialization process. The carriage position information initialization process refers to a process in which the CPU 101 writes any value to the servo control position counter C1 to initialize position information of the carriage 12. This process may be performed at a position where an absolute position and a value of the servo control position counter C1 are secured. The absolute position refers to a position where the absolute position of the carriage 12 is secured. For example, the absolute position is a position reached by moving the carriage 12 beyond a maintenance position into abutment with a side surface of the main body. Also, the absolute position may be a capping position at which the maintenance unit 19 caps the carriage 12 (maintenance position). The values of the servo control position counter C1 at these absolute positions are held, for example, in the SROM 112 in the process of manufacturing the printing apparatus 11. In sum, the CPU 101 writes the value corresponding the absolute position that is held in the SROM 112 to the servo control position counter C1 to initialize the position information of the carriage 12. Note that the abutment position and the capping position are described as examples of the position where an absolute position and a value of the servo control position counter C1 are secured, but the position is not limited to these examples. The position where an absolute position and a value of the servo control position counter C1 are secured can be considered a reference position based on which the position information is updated. Also, the value of the servo control position counter C1 secured for the absolute position (reference position) can be considered reference position information.

In S508, the printing apparatus 11 moves the carriage 12 to the position where an absolute position and a value of the servo control position counter C1 are secured, and performs a process of writing any value to the servo control position counter C1 from the CPU 101. The value written at this time is the secured value of the servo control position counter C1 for the position where an absolute position and a value of the servo control position counter C1 are secured. At the same time as writing any value to the servo control position counter C1 from the CPU 101, the same value is written to higher-order bits of the ejection control position counter C2, as described earlier. This process eliminates the difference in the correlation between the two counters due to the effect of the noise. After S508, the process proceeds to S509.

In S509, the printing apparatus 11 moves the carriage 12 to a stand-by position. The stand-by position may be the same as the maintenance position, at which the maintenance unit 19 caps the carriage 12. Note that, in a case where the carriage position information initialization process in S508 is performed with the maintenance position as the absolute position, the carriage 12 does not need to be moved in S509. After S509, the printing apparatus 11 terminates the process of the flowchart illustrated in FIG. 5.

As described above, according to the present embodiment, it is possible to properly specify the position of the carriage 12. For example, even in a case where an encoder signal is affected by an unexpected noise, it is possible to provide a proper print product without image defects. Also, in the present embodiment, if an encoder signal affected by noise in a case where the cover is closed, for example, it is possible to remove the effect of the noise before a next print job is performed. As described above, in the present embodiment, the value of a position counter in a state where an absolute position and a value of the position counter are secured is held in advance. Then, in a case where an encoder signal is affected by noise or the like while the cover is open or in a similar situation, and it is detected that the value of a position counter has become abnormal, a normal value is written to the position counter at a position where the correlation between the absolute position and the position counter is known. For example, a normal value is written to the position counter in a state where the carriage 12 is moved into abutment with a side surface of the main body. This removes the effect of the noise.

### Other Embodiments

In the above-described embodiment, an example in which the servo control position counter C1 and the ejection control position counter C2 are used in the counter information comparison process has been described. Specifically, an example in which whether a counter is experiencing abnormality is detected based on the correlation between the servo control position counter C1 and the ejection control position counter C2 has been described. Here, the counter information comparison process may be performed by another method. For example, information on the servo control position counter C1 and the ejection control position counter C2 in a state where the cover is open may be held and compared with information on the servo control position counter C1 and the ejection control position counter C2 in a state where the cover is closed. That is, the counter values before and after opening the cover may be compared with each other. Then, in a case where a difference is present, the carriage position information initialization process may be performed. Note that the user may manually move the carriage 12 in the state where the cover is open. In such a case, there will be a difference between the counter values in the state where the cover is open and in the state where the cover is closed. Thus, there is a possibility of detecting a difference even although it is not a difference attributable to the effect of noise or the like. The carriage position information initialization process may of course be performed in a case where a difference due to manual movement of the carriage 12 by the user is detected.

Also, in the above-described embodiment, an example has been described in which the counter information comparison process and the carriage position information initialization process, which is a recovery process, are performed in a case where the cover is closed since an encoder signal is likely to be affected by noise in a case where the cover is opened. Here, it is also possible to regularly perform the counter information comparison process and, in a case where it is determined that a recovery process is necessary, perform the carriage position information initialization process, provided that the processing capacity of the CPU 101 permits it. For example, the counter information comparison process may be performed between scans during the execution of a printing operation based on a print job. Furthermore, the counter information comparison process may be performed at any timing.

Also, in the above-described embodiment, an example in which the carriage 12 is moved to an absolute position and the carriage position information initialization process is performed has been described. Here, the servo control position counter C1 may be overwritten without moving the carriage, as long as the cover is closed and there will be no factors without fail that change the servo control position counter C1. In this way too, the carriage position information initialization process can be performed.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to properly specify the position of a carriage.

This application claims the benefit of Japanese Patent Application No. 2025-031418, filed February 28, 2025, which is hereby incorporated by reference herein in its entirety.

What is claimed is:

1. A printing apparatus comprising:
a carriage carrying a print head configured to eject an ink onto a print medium;
an encoder configured to output a signal indicating a position of the carriage;
a position counter configured to count a value based on the signal output from the encoder;
a unit configured to generate an ejection signal to be used for ejection by the print head based on the value of the position counter;
a unit configured to hold the value of the position counter, as reference position information, which corresponds to a position where an absolute position and position information of the carriage are secured; and
a unit configured to update the position counter based on the reference position information in a case where the value of the position counter is abnormal.

2. The printing apparatus according to claim 1, wherein the position where an absolute position and position information of the carriage are secured is a position reached by moving the carriage into abutment with a side surface of a main body of the printing apparatus.

3. The printing apparatus according to claim 2, wherein the unit configured to update the position counter moves the carriage into abutment with the side surface of the main body of the printing apparatus and updates the position counter.

4. The printing apparatus according to claim 1, wherein the position where an absolute position and position information of the carriage are secured is a position at which the print head is capped.

5. The printing apparatus according to claim 4, wherein the unit configured to update the position counter moves the carriage to the position at which the print head is capped, and updates the position counter.

6. The printing apparatus according to claim 1, further comprising an access cover configured to allow a user to access the carriage, wherein
the unit configured to update the position counter determines whether the value of the position counter is abnormal in response to closing of the access cover.

7. The printing apparatus according to claim 1, wherein
the position counter includes a servo control position counter to be used to control movement of the carriage and an ejection control position counter, and
whether the value of the position counter is abnormal is determined from a correlation between the servo control position counter and the ejection control position counter.

8. The printing apparatus according to claim 7, wherein the value of the position counter is determined be abnormal in a case where a value of the ejection control position counter is not a multiple of a value of the servo control position counter.

9. The printing apparatus according to claim 6, wherein whether the value of the position counter is abnormal is determined from the values of the position counter before and after opening the access cover.

10. The printing apparatus according to claim 9, wherein the value of the position counter is determined to be abnormal in a case where the values of the position counter before and after opening the access cover are different.

11. A method of controlling a printing apparatus including
a carriage carrying a print head configured to eject an ink onto a print medium,
an encoder configured to output a signal indicating a position of the carriage,
a position counter configured to count a value based on the signal output from the encoder,
a unit configured to generate an ejection signal to be used for ejection by the print head based on the value of the position counter, and
a unit configured to hold the value of the position counter, as reference position information, which corresponds to a position where an absolute position and position information of the carriage are secured,
the method comprising:
detecting that the value of the position counter is abnormal; and
updating the position counter based on the reference position information in a case where the value of the position counter is detected to be abnormal.
